(19) United States
(12) Patent Application Publication
(10) Pub. No.: US 2026/0061697 A1
(43) Pub. Date: Mar. 5, 2026

(54) Graphene Coated Polymer Particulate Powder

(71) Applicant: GrapMatech AB, Uppsala (SE)

(72) Inventors: Andrea Spanou, Hägersten (SE); Johan Magnusson, Uppsala (SE)

(21) Appl. No.: 19/105,893

(22) PCT Filed: Aug. 26, 2023
(86) PCT No.: PCT/EP2023/073455

§ 371 Date: Feb. 24, 2025

(30) Foreign Application Priority Data
Aug. 26, 2022 (SE) 2250987-1

(51) Int. Cl. B29C 64/153; B29K 23/00; B29K 27/00; B29K 67/00; B29K 105/00; B33Y 70/10; B33Y 80/00; C08K 3/04

(52) U.S. Cl. CPC B29C 64/153; C08K 3/042; B29K 2023/065; B29K 2027/14; B29K 2067/00; B29K 2105/251; B33Y 70/10; B33Y 80/00

(57) ABSTRACT

The present disclosure relates to conducting polymer powder. In particular, it relates to composite powder material including particulate polymer and graphene, wherein the particulate polymer is coated with graphene, and wherein the graphene concentration is 0.03-1.5% in weight per weight of the particulate polymer. The polymer is selected from the group consisting of polyamide, thermoplastic fluoropolymer, polyethylene, and polyurethane. The polyamide is selected from the group consisting of PA6, PA11, PA12, PA66.

### CROSS-REFERENCE TO RELATED APPLICATIONS

This application is the United States national phase of International Patent Application No. PCT/EP2023/073455, filed Aug. 26, 2023, and claims priority to Swedish Patent Application No. 2250987-1, filed Aug. 26, 2022, the disclosures of which are hereby incorporated by reference in their entireties.

### BACKGROUND OF THE INVENTION

### Field of the Invention

The present invention relates to polymers and in particular to graphene coated polymer powder.

Graphene can be added to other materials forming composites that shows improved or even new properties as compared to the basic material. For example, it is known that a polymer-graphene composite material can exhibit electrical conductivity. Such a property is highly interesting from a commercial point of view for many different applications.

Polymers are interesting materials when it comes to additive manufacturing (AM) or 3D printing. In addition, polymers are of interest for a wide range of applications using different manufacturing techniques, such as molding. Polymer powder can be added to an additive manufacturing (AM) device such as a 3D printer in order to form a printed product. However, due to the low electrical conductivity of polymers, their use in AM is limited to applications that do not require electrical conductivity. Today this problem is addressed by adding different fillers in the form of e.g. metal, carbon black, etc. to the polymer powder. However, achieving high electrical conductivity requires a high proportion of a in the composite resulting in brittle polymer composites that are difficult to process and/or not providing the desired properties in the end product. Moreover, due to the low conductivity of the powder static charges can build up on the powder surface while handling the powder. The static charge results in both attractive and repelling electrical forces between the powder particles, thus decreasing flowability, and increasing dusting.

Polymer powders can also be used for the production of solid parts using different molding techniques such as rotational molding, extrusion, or injection molding. Many applications put high requirements on the used polymers such as high mechanical strength, or Electro-Static Discharge. There are several routes to improve the intrinsic properties of the polymer. One is adding a filler, e.g. carbon black, carbon fiber or metal to the polymer product. Another is adding a chemical to cross-link the polymer and thereby improve mechanical strength. However, the cross-linking requires careful tuning of temperature and time for cross-linking which may make the rotational molding process more complex. Adding carbon-based fillers such as carbon black and carbon fiber at the high inclusion levels needed may risk embrittlement and limited processability. Other problems may be that some properties degrade, whereas others are improved by the filler additions to the polymer. Therefore, there is a need for fillers which can be added at low concentrations, and which improve several properties which are needed to fulfill requirements on the polymer part.

### Description of Related Art

A. Ronca et al. Appl. Sci. 2019, 9, 864, discloses electrically conductive and flexible thermoplastic polyurethane/graphene porous structures fabricated by SLS starting from graphene-wrapped thermoplastic polyurethane powders.

M. Li et al. Carbon, 2013, 65, 371-373, discloses electrically conducting polymer and reduced graphene oxide composites with segregated structure.

De Leon et al., ACS Appl. Energy Mater. 2018, 1, 1726-1733, DOI: 10.1021/acsaem.8b00240, show conductivity measurements for a PA powder coated with various concentrations of reduced graphene oxide (Rgo).

In the prior art there is still a need for polymer particles with high electrical conductivity suitable for different manufacturing techniques including AM.

### SUMMARY OF THE INVENTION

The object of the present invention is to provide electrically conducting polymer powder or particles that for example can be used for different applications and/or for different manufacturing techniques, such as in AM, injection and rotational molding applications. A further object is to provide a printed polymer product that is electrically conductive. Yet a further objective is to provide a molded polymer product with improved mechanical strength and/or Electro-Static Discharge properties.

This is achieved by the particles defined herein, and the printed polymer product defined herein.

In one aspect of the invention there is a composite powder material comprising particulate polymer and graphene, wherein the particulate polymer is coated with graphene, and wherein the graphene concentration is 0.03-1.5% in weight per weight of the particulate polymer, wherein the polymer is selected from the group consisting of polyamide, thermoplastic fluoropolymer, polyethylene, and polyurethane, wherein the polyamide is selected from the group consisting of PA6, PA11, PA12, PA66.

In one embodiment of the invention the concentration of graphene is approximately 0.6-1.5% in weight per weight of the particulate polymer.

In one embodiment of the invention the concentration of graphene is approximately 0.8-1.0% in weight per weight of the particulate polymer. In one embodiment of the invention the concentration of graphene is approximately 0.8% in weight per weight of the particulate polymer.

In one embodiment of the invention the graphene is reduced graphene oxide or graphene oxide.

The particulate polymer may comprise additional components, such as fillers. These components may be carbon-based, such as carbon black. Results show that these particulate polymers with fillers can be coated in the same way as described herein. Such particulate polymers with fillers are commonly used for 3D-printing, such as with selected laser sintering (SLS).

In one embodiment of the invention the polymer polymer is polyester thermoplastic polyurethane (TPU).

In one embodiment of the invention the polymer is low-density polyethylene.

In one embodiment of the invention wherein the thermoplastic fluoropolymer is a polyvinyl fluoride, such as poly(vinylidene fluoride-trifluoroethylene).

In an embodiment, the polyamide is PA11 or PA12.

In one embodiment of the invention the shape of the particulate polymers is spherical.

In one embodiment of the invention the shape of the particulate polymers is oval/fragmented.

In one embodiment of the invention the average particle size of the particulate polymer particles is 20-500 μm, preferably 50-80 μm.

In an embodiment of the composite material, the polymer is crosslinked polyethylene, such as cross-linked high-density polyethylene.

In another embodiment of the composite material, the polymer is crosslinkable polyethylene, such as cross-linkable high-density polyethylene. In this embodiment, the crosslinkable polyethylene has not undergone heat treatment to form crosslinked polyethylene or crosslinked high-density polyethylene.

Further embodiments are appended herein.

In a second aspect of the invention there is a printed polymer product, manufactured from a composite powder material comprising particulate polymer and graphene. The particulate polymers are coated with graphene, and the graphene concentration is 0.3-1.5% in weight per weight of the particulate polymer. The printed product has a resistivity below 400000 ohm cm. The composite powder material may be the composite powder material according to any one of the aspects or embodiments described above and below.

Further aspects may include one or more of:

A Selective Laser Sintering (SLS) printed polymer product, manufactured from a composite powder material according to the first aspect, wherein the graphene concentration is 0.05-1.5% in weight per weight of the particulate polymer and the printed product has a volume resistivity below 400000 ohm cm;

A Selective Laser Sintering (SLS) printed polymer product, manufactured from a composite powder material according to the first aspect, and wherein the graphene concentration is 0.3-1.5% in weight per weight of the particulate polymer and the printed product has a volume resistivity below 2000 ohm cm;

A rotational molded product, manufactured a composite powder material according to the first aspect, wherein the graphene concentration is 0.6% in weight per weight of the particulate polymer and the product has a volume resistivity below 150000 ohm cm, with an average value of 56000 ohm cm;

An injection molded product, manufactured from a composite powder material according to the first aspect, and wherein the graphene concentration is 0.6% in weight per weight of the particulate polymer and the product has mechanical properties including mechanical strength, elongation at break, and Youngs modulus are increased in relation to the neat polymer.

In the following the invention will be described in more detail with non-limiting embodiments thereof and with reference to the accompanying drawings.

### ABBREVIATIONS

AM—additive manufacturing;
RM—rotational molding
IM—injection molding
G—graphene
GO—graphene oxide
rGO—reduced graphene oxide
HF—Hausner Factor
rGO—reduced graphene oxide
SEM—scanning electron microscopy
SLS—selective laser sintering
HDPE—High Density Polyethylene
LDPE—Low Density Polyethylene
XLPE—Crosslinked or crosslinkable polyethylene

### BRIEF DESCRIPTION OF THE DRAWINGS

The terms Fig., Figs., Figure, and Figures are used interchangeably in the specification to refer to the corresponding figures in the drawings.

FIG. 1 shows a schematic illustration of a cross-section of a composite particle according to the invention;

FIGS. 2 a)-d) show SEM images of embodiments according to the invention;

FIGS. 3 a)-d) show SEM images of embodiments according to the invention, and FIG. 3 e) shows SEM images of a comparative example;

FIGS. 4 a) and 4 b) show measured resistivity and sheet resistance values for embodiments according to the invention;

FIGS. 5 a)-d) show SEM images of embodiments according to the invention;

FIG. 6 shows a flow-chart according to an embodiment of the invention;

FIGS. 7 a)-c) show a schematic illustration of a measurement device;

FIG. 8 shows measured resistivity of embodiments based on PA11 according to the present disclosure;

FIG. 9 shows a comparison of volume resistivity data of the present disclosure compared to volume resistivity data obtained from de Leon et al., ACS Appl. Energy Mater. 2018, 1, 1726-1733, cited above; and

FIGS. 10 a), 10 b), and 10 c) show SEM images of PA11 particles coated with graphene according to an embodiment of the invention with increasing magnification, respectively, and FIG. 10 d) shows a SEM image of the PA11 particles without graphene coating.

### DESCRIPTION OF THE INVENTION

There is a growing demand in industry for conducting polymers. There are several different applications for such materials, not at least for their use in different manufacturing and additive manufacturing techniques where they can be used to manufacture conducting polymeric products. The manufacturing techniques include for example SLS printing, rotational and injection molding and/or extrusion.

Since polymers generally are not conducting in themselves, one way to make them conductive is to add an additive to the polymer forming a composite powder material or a mixture of a polymer and an additive. The additive should be conductive and overall compatible with the polymer particulate powder. Graphene is a 2-dimensional carbon material that is highly conductive. Graphene is a layered material in the form of flakes or sheets. Graphene comprises at least 50 at % carbon, has a hexagonal lattice and a thickness 1-20 times the size of a carbon atom. Herein ‘graphene’ includes single layer graphene, few layers graphene, graphene oxide (GO), reduced graphene oxide (rGO), graphene nanoplatelets (GnNP) etc.

In the prior art there exists mixtures of polymer particles and carbon-based additives such as graphene. However, mixtures with the presence of free graphene flakes have disadvantages such as worse processability, which is particularly important for different 3D printing techniques and molding techniques.

Free graphene flakes may be flakes that are not attached to the surface of the particulate polymer. Additionally, the presence of free graphene flakes or other micro or nano carbon particles can be related to negative health and safety aspects. Furthermore, mixtures of graphene and polymer are less homogenous than a particulate powder material according to the invention. Homogenous dispersion of the graphene additive in the polymer matrix has advantages of obtaining an isotropic material as well as lowering the percolation threshold.

In a first aspect of the invention there is a composite powder material comprising particulate polymer and graphene, wherein the particulate polymers are coated with graphene, and wherein the graphene concentration is 0.3-1.5% in weight per weight of the particulate polymer.

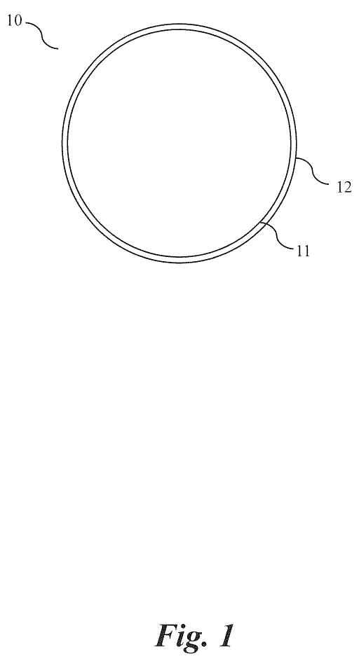

The term ‘coating’ herein refers to that the graphene flakes are located on the surface of the polymer particles or the particulate polymer, where they adhere to the polymer particle. A schematic illustration of a cross-section through the middle of such a coated composite polymer particle 10 can be seen in FIG. 1.

As can be seen in FIG. 1 the coated composite polymer particle 10 comprises a solid polymer core 11 surrounded by a shell or coating layer of graphene 12. This differs from, for example mixtures of particulate polymer and graphene wherein the particulate polymer is not coated with graphene but instead the graphene flakes and the polymer particles are individually distinct. That the polymer particles or particulate polymer is coated with graphene can for example be seen when analyzing a sample according to the invention with SEM. What can be seen in a SEM image of a typical composite powder according to the invention is that the graphene flakes are located on the surface of the polymer particles or particulate polymer. Additionally, there are no, or almost no, flakes in between the particles.

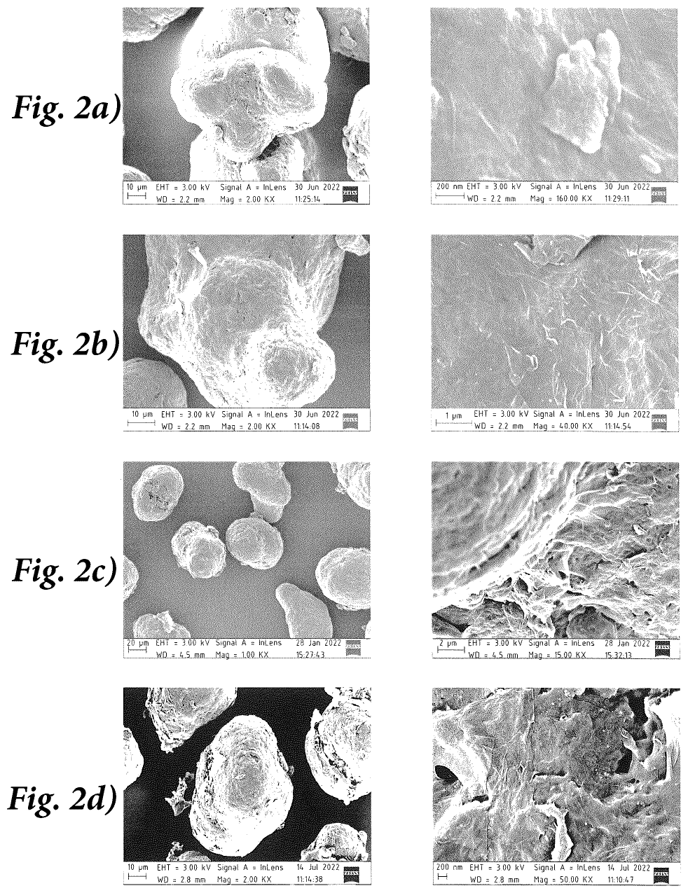

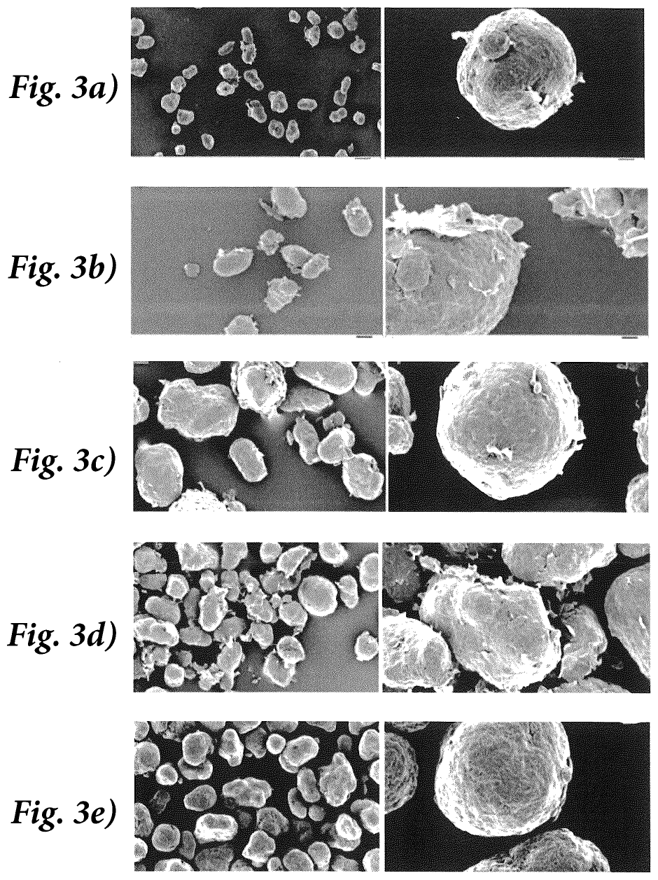

FIGS. 2 a)-d) show SEM images of composite powder material or particulate material according to the invention. The terms ‘powder material’, ‘particulate material’, and ‘particles’ refer to a volume of particles wherein the mean size of the particles is <1 mm. The terms are used interchangeably herein. The composite particles in FIGS. 2 a)-d) are coated with different concentrations of graphene: a) 0.1 wt %; b) 0.3 wt %; c) 0.8 wt %; and d) 1.5 wt %, respectively. FIGS. 3 a)-e) additionally show composite particles according to the invention coated with different concentrations of graphene compared with a reference: a) 0.6 wt %; b) 0.8 wt %; c) 1 wt %; d) 1.5 wt %; and e) reference, respectively. The reference is an uncoated polymer sample. The images on the right-hand side are zoomed in version of those on the left-hand side.

Composite powder material according to the invention shows an increased electrical conductivity as compared to non-coated powder material. Electrical conductivity can be determined by measuring the resistivity, as conductivity is the inverse of resistivity. A decrease in resistivity equals an increase in conductivity. The desired level of conductivity depends on the indented application for the composite polymer powder or the product manufactured by the composite polymer powder. In many applications as high conductivity as possible is aimed for. A polymer powder material according to the invention has an increased conductivity as compared to a non-coated polymer powder material.

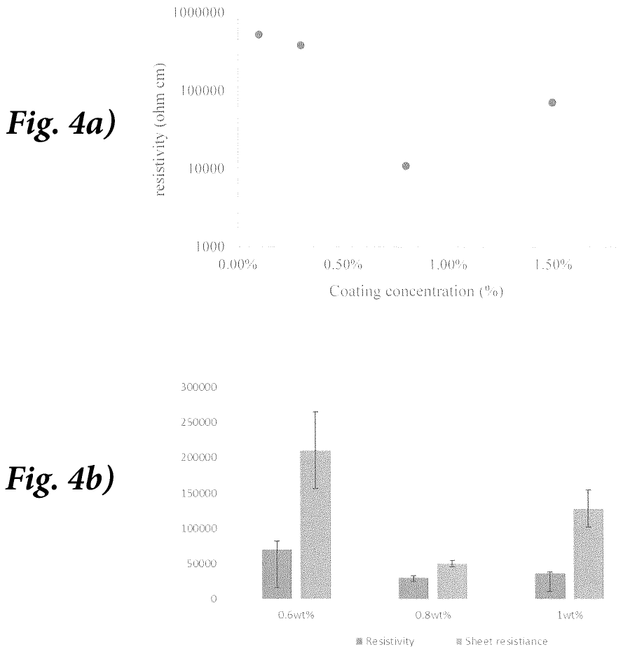

FIG. 4 a) shows the volume resistivity as a function of coating concentration for a composite powder material according to the invention. FIG. 4 b) shows the volume resistivity and sheet resistance for printed parts comprising composite powder materials according to the invention. To measure the resistivity of a composite powder material according to the invention, the powder is pressed between two electrodes in a pellet of fixed volume. The resistance is measured between the two electrodes. The resistivity is determined by the formula ρ=(R*A)/l, where p is resistivity, R is resistance, A is area in contact with the electrodes and I is the length between the electrodes. For the printed parts, the data in FIG. 4 b), the resistance was measured using a four-point probe. Seven measurements were performed on one sample per category. As can be seen the composite powder and the printed parts comprising the composite powder both show a low resistivity.

In one embodiment of the invention the concentration of graphene is approximately 0.3-1.5% in weight per weight of the particulate polymer, or 0.6-1.5% in weight per weight of the particulate polymer, or 0.8-1.0% in weight per weight of the particulate polymer, or approximately 0.8% in weight per weight of the particulate polymer.

Graphene exists in many forms: pristine graphene, graphene oxide, reduced graphene oxide, functionalized graphene, etc. In one embodiment of the invention the coating comprises reduced graphene oxide. During a manufacturing process of coating a polymer powder material graphene oxide (GO) is reduced to form reduced graphene oxide (rGO). Hence, in such embodiment of the invention the particulate polymer is coated with rGO and a composite powder material accordingly comprises particulate polymer and rGO.

Graphene oxide is fairly abundant and often used in different applications.

The composite polymeric powder material according to the invention may be any type of polymer, having any average particle size and any type of morphology. The electrical conductivity may be influenced by the morphology of the powders. In particular a regular shape or morphology wherein the particles can be packed better may result in a higher electrical conductivity. In one embodiment of the invention the shape of the composite particulate powder material is essentially spherical or elliptical. As obvious to the skilled person, that the shape of the particles is spherical includes some variation in the shape.

In one embodiment of the invention the polymer is selected from the group consisting of polyamides, thermoplastic fluoropolymers, polyethylene, and polyurethanes.

Polymers is a large class of material that consist of materials comprising many repeating subunits. Thermoplastics is a class of polymer that is widely used in industry and interesting for many different applications. Thermoplastics include polyamides (PA), polyurethane (TPU), polyethylene (PE), and fluorinated thermoplastics such as polyvinyl fluoride (PVDF). Polyamides (PA) are engineering polymers with high durability and strength and are widely used in polymer powder additive manufacturing. Polyurethanes (TPU) are rubbery thermoplastics that are widely used where flexibility and sealing properties are important. Polyethylene (PE) is the most commonly used plastic in industry. Fluorinated thermoplastics such as PVDF are a special family of engineering polymers which are widely used in applications such as electrical, electronic, sensors, actuators, biomedical, construction, fluid-systems, oil-and-gas, and food industries.

In one embodiment of the invention the polymer is a polyamide selected from the group consisting of PA6,PA11, PA12, and PA66. In one embodiment of the invention the polymer is a polyurethane selected from the group consisting of TPU polyesters such as Estane PW600. In one embodiment of the invention the polymer is a polyethylene selected from the group consisting of low-density polyethylene (LDPE). In one embodiment of the invention the polymer is a polyvinyl fluoride selected from the group consisting of Piezotech FC20, and PVDF copolymers such as polyvinylidene fluoride-trifluoroethylene (PVDF-TrFE).

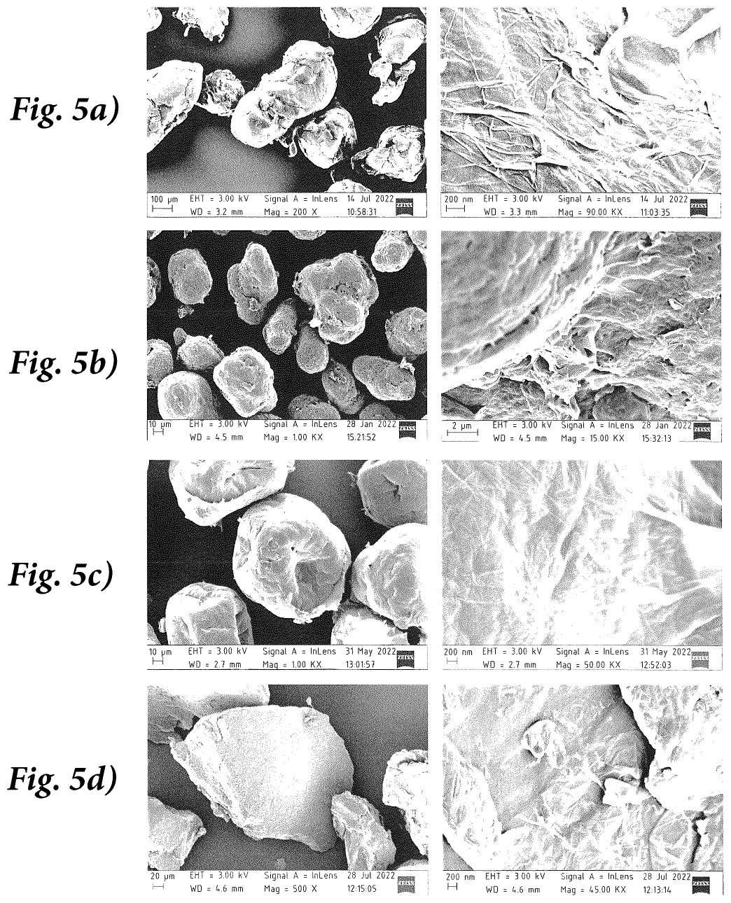

FIGS. 5 a)-d) show examples of different polymers according to the invention: a) PE; b) PA; c) PVDF; and d) TPU, all coated with 0.8% graphene in weight per weight of the particulate polymer. The images on the right-hand side are zoomed in version of those on the left-hand side. As can be seen from the figures: composite polymer powder material according to the invention can vary in size and morphology. The particle size of the particulate polymer can influence the coating during the manufacturing, for example if the particles are too small the graphene flakes may wrap two particles in the same graphene flake instead of one.

In one embodiment of the invention the average particle size of the composite particulate polymer particles is 20-200 μm, preferably 20-80 μm, for example 50-80 μm. The average particle size for the particulate composite polymer powders can be determined by methods known to the skilled person. It can for example be determined by analyzing the samples with SEM, and determine the average particle size from the micrographs.

In a second aspect of the invention there is a method for manufacturing a composite powder material 100 wherein the method comprises the steps of:
110: Mixing step: mixing of graphene, a water-soluble salt, an aqueous solvent, an acid and particulate polymer forming a mixture;
120: Reduction step: keeping the mixture at room temperature or higher a for a predetermined time period during which the graphene is reduced, forming a reduced mixture;
130: Washing step: washing the reduced mixture using a solvent, for example deionized water forming a washed mixture;
140: Powder retrieval step: filtration of the washed mixture to obtain polymer particles; and
150: Drying step: drying of the polymer particles at a predetermined temperature.

The acid causes a reduction of the graphene oxide to form reduced graphene oxide (rGO), which is conductive. Alternatively, the mixing step 110 may be performed without acid. No or less rGO may be formed in this case. The graphene oxide present in the coating may then be reduced to rGO in further processing steps, such as during molding or 3D-printing (e.g. with SLS).

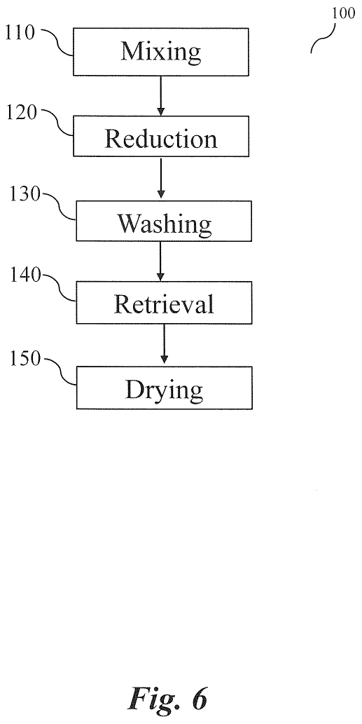

FIG. 6 shows a flow-chart of the method 100. In one embodiment of the second aspect the graphene is graphene oxide. In one embodiment of the second aspect the polymer is selected from the group consisting of polyamides, thermoplastic fluoropolymers, polyethylenes, and polyurethanes.

In a third aspect of the invention there is a printed polymer product. The printed polymer product is manufactured by a composite powder material according to the invention. The printed polymer product has a low electrical resistivity and hance a high electrical conductivity. This can for example be seen in FIG. 4 b) that shows the electrical volume resistivity in ohm cm and sheet resistance in ohm/sq. for printed parts comprising a composite powder material according to the invention. The printed product has a resistivity below 400000 ohm cm.

All aspects and embodiment can be combined with each other.

### EXAMPLES

### Materials and Methods

Seven different polymers were used, see Table 1. For the process deionized water, sodium chloride and ascorbic acid was additionally used.

TABLE 1
Several polymers used in the study

| | | Average particle | |
|---|---|---|---|
| Polymer name | Polymer type | size (μm) | Morphology |
| PA2200 | Polyamide (PA) | 60 | round |
| LDPE | Polyethylene (PE) | 500 | oval/ |
| | | | fragmented |
| Estane PW600 | Polyurethane (TPU) | 200 | fragmented |
| Piezotech FC20 | Fluorinated polymer | 100 | round |
| | (PVDF) | | |

PA2200 is the well-known product of the company EOS for PA12 powder for 3D-printing. Printed products made from PA2200 have as typical mechanical properties in xy print direction: tensile modules 1650 MPa, tensile strength 48 MPa, strain at break 18% (ISO 527). The density of a printed product is 930 kg/m³ and melting temperature 176° C. (at a heating rate of 20° C./min, ISO 11357-1/-3).

In addition to the above, PA11 powder was used. The PA11 was the product sold as PA1101 by EOS. Printed products made from PA1101 have as typical mechanical properties in xy print direction: tensile modules 1600 MPa, tensile strength 48 MPa, strain at break 45% (ISO 527). The density of a printed product is 990 kg/m³ and melting temperature 201° C. (at a heating rate of 20° C./min, ISO 11357-1/-3).

Further, cross-linkable polyethylene (XLPE) powder was coated with graphene and the resistivity of the coated powder was measured.

Also, high-density polyethylene (HDPE) powder was coated with graphene. Subsequently, the produced powder was blow molded to form a part and the resistivity was measured.

### Coating Process

Graphene oxide (GO) and deionized water was mixed/stirred rigorously at 60° C. After that polymer powder was added to the mixture, the mixture was continuously stirred. Sodium chloride in the amount of 40× the amount of GO was added. When the sodium chloride was fully dissolved ascorbic acid in the amount of 5× the amount of GO was added to the solution. The mixture was continuously stirred for 24 hours. After 24 hours the powder was filtered and washed several times using deionized water, after the washing the powder was dried in an oven overnight at 60° C. The powders were coated with 0.6; 0.8; 1.0; and 1.5 wt % graphene. The resulting coating in this case is rGO.

Alternatively, chemical reduction can be omitted, where ascorbic acid is not added to the mixture. The same steps are followed regarding the addition of sodium chloride and the GO. The resulting coating in this case is GO. GO coatings can be reduced in certain manufacturing processes, for example SLS printing, where thermal reduction is induced.

### 3D Printing Process

The coated powders were printed using an SLS printer from Sintratec AG, Switzerland, Wematter (Sweden), Sinterit (Poland), and Sharebot (Italy).

### Characterization

The sheet resistance and conductivity of the printed parts was measured using a 4-point probe (CMT-SR2000N, AIT). The coated powders were examined with SEM (Leo 1530, Zeiss) with an acceleration voltage of 3 kV using an In-lens detector to evaluate morphology. The flowability of the powders were analyzed using the Hausner Factor (HF), i.e. the ratio between the tapped and untapped density of the powder.

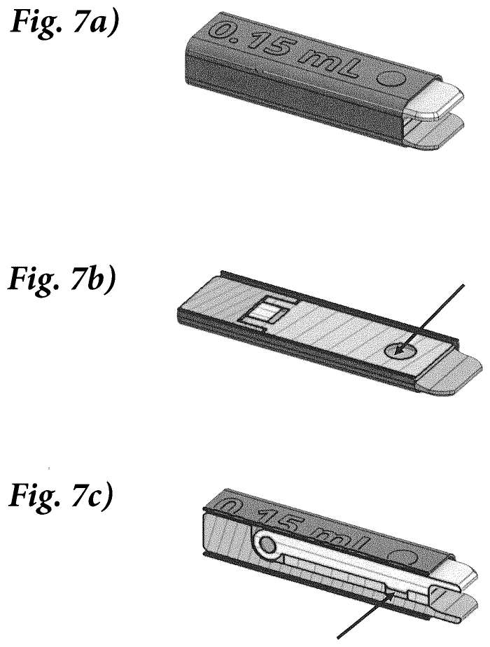

The volume resistivity of the powders was determined by measuring the resistance on a volume of powder, and afterwards calculating the volume resistivity using the resistivity formula (1):

$$ρ = \frac{R \cdot A}{l} \qquad ( 1 )$$

wherein ρ is the resistivity, R is the measured resistance, A is the cross-sectional area, and l is the length. The resistance was measured using the device illustrated in FIGS. 7 a)-c). A fixed volume of powder is pressed between two conductive plates and the resistance is measured using two probe multimeter. Using the dimensions of the capsule the volume resistivity and conductivity can be determined. FIG. 7 a) shows the full view of the device, b) shows a side cross section, and c) shows a top cross section. The arrows indicate where the powder is loaded.

Flowability tests were performed using ASTM B213 standard, adjusted for polymer powders.

### Results

### Example 1: PA12

A successful coating was achieved for all four tested concentrations: 0.6; 0.8; 1.0; and 1.5 wt %. SEM images can be seen in FIGS. 2 a)-d). For the 1.5 wt % sample some flaking was observed. The sheet resistance and resistivity results of printed parts are shown in FIG. 4 b). FIG. 4 b) shows resistivity (ohm cm) and sheet resistance (ohm/sq) of the printed parts measured using a four-point probe. Seven measurements were performed on one sample per category.

The flowability of the powders was measured after coating and after printing. The results are summarized in Table 2. After coating the powders 0.6 wt % showed a slight increase in the HF value.

TABLE 2
Flowability of the powders compared to a reference (non-coated)

| | | % change | | |
|---|---|---|---|---|
| Coating | | compared to | HF after | % HF increase |
| [wt %] | HF | reference | printing | after printing |
| Ref | 1.203 | — | — | — |
| 0.6 | 1.218 | +1.25 | 1.260 | +3.44 |
| 0.8 | 1.200 | −0.25 | 1.432 | +19.3 |
| 1.0 | 1.172 | −2.58 | 1.286 | +9.73 |

The cross sections of the printed parts were also examined, revealing less sintered sites on the coated parts compared to the reference.

### Example 2: PA12, PE, PVDF, TPU

All polymer types could be coated with concentrations of 0.1-1.5 wt % GO. FIGS. 5 a)-d) show SEM images of coated samples for all polymers: a) PE; b) PA; c) PVDF; and d) TPU. FIG. 4 a) shows the resistivity as a function of the coating concentration. For concentrations higher than 1.5 wt % excessive flaking were observed and they were not analysed for resistivity. Table 3 shows the resistivity for different polymer powders coated with 0.8 wt % GO.

TABLE 3
Resistivity for different polymer powders with 0.8 wt % coating.

| Polymer type | Resistivity (Ohm · cm) |
|---|---|
| PA12 | 10891 |
| PVDF | 6004 |
| PE | 36250 |
| TPU | 248954 |

### Example 3: LDPE

Samples of LDPE powder coated with a concentration of 0.6 wt % rGO exhibited a resistivity between 36000 and 100000 Ohm·cm, with an average of 64000 Ohm·cm. In particular, the PE powder was LDPE powder.

For the flowability measurements 20 g of the 0.8 wt % coated PA12 powder was used and it was compared to a non-coated reference. The non-coated reference powder did not flow through the apparatus, even after extensive drying. The coated powder exhibits better flowability. The average flowability for the 0.8 wt % coated powder is shown in Table 4a.

Parts printed with SLS and with a rGO coating concentration of 0.3 wt % exhibited a volume resistivity of 573 Ohm·cm. The sheet resistance was 3561 ohm/sq.

TABLE 4a
Flowability for PA powder with 0.8 wt % coating.

| Average flowability | 59.3 sec/50 g |
|---|---|
| deviation | 1.1 sec/50 g |
| deviation | 1.9% |

The mechanical properties of injection molded parts produced with this LDPE powder comprising 0.6 wt % rGO were obtained by measurements according to ISO 527:2019 tybe B and are shown in the Table 4b below compared to a reference molded in the same way but using the same polymer powder without rGO coating. The values after the “±” sign indicate the standard deviation. As can be seen, the addition of the coating has a large positive effect on all the measured mechanical properties, which include Young's modulus, yield strength, tensile strength, and elongation at break.

TABLE 4b
Mechanical properties of injection molded
parts as measured by ISO 527: 2019 type B

| | | Parts from 0.6% | |
|---|---|---|---|
| | | wt. % coated | Graphene |
| Property | Reference | powder* | Impact |
| Modulus [MPa] | 508 ± 32.6 | 559 ± 63.2 | +10% |
| Yield Strength [MPa] | 14.4 ± 0.325 | 15.5 ± 0.293 | +7.6% |
| Tensile Strength [MPa] | 10.5 ± 3.78 | 15.0 ± 2.65 | +43% |
| Elongation at break [%] | 307 ± 179 | 507 ± 196 | +65% |

### Example 4: HDPE

HDPE powder (Plastene R180, Poliplast, Italy), was coated using 0.6 wt % rGO. Part samples of coated powder were prepared by blow molding in rectangular boxes. The boxes showed a mat side on the outside and a glossy side on the inside. For both sides the resistivity was measured as shown in the below Table 5.

TABLE 5
Resistivity measurements of HDPE parts

| | Width | Length | Thickness | Volume resistivity | Volume resistivity |
|---|---|---|---|---|---|
| Sample | (mm) | (mm) | (mm) | (Mat) (Ohm · cm) | (Glossy)(Ohm · cm) |
| 1 | 30 | 21 | 2.00 | 1.5 × 10⁵ | 1.0 × 10⁵ |
| 2 | 30 | 21 | 1.95 | 4.0 × 10⁴ | 4.8 × 10⁵ |
| 3 | 30 | 21 | 1.88 | 3.3 × 10⁴ | 7.2 × 10⁴ |
| 4 | 30 | 21 | 1.90 | 4.2 × 10⁴ | 3.1 × 10⁴ |
| 5 | 30 | 21 | 1.67 | 3.2 × 10⁴ | 4.1 × 10⁴ |
| 6 | 30 | 21 | 1.74 | 3.7 × 10⁴ | 5.1 × 10⁴ |
| | | | Average | 5.6 × 10⁴ | 1.3 × 10⁵ |

### Example 5: Crosslinkable PE (XLPE)

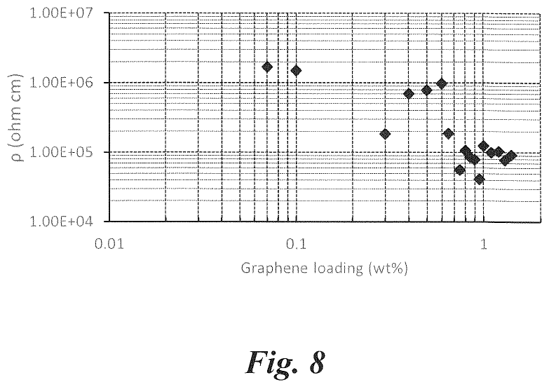

XLPE powder (SuperLink 114NA XLPE of Ingenia Polymer Corp.) was coated within the concentration range of 0.2-1.5 wt % rGO. This XLPE has a composition that causes chemical cross linking to occur when heated. The maximum degree of cross-linking lies in the range of 70-84%. The XLPE powder is particularly suitable for rotational-molding. Table 6 shows the obtained volume resistivity values for the various concentrations. The results are also shown in the graph of FIG. 8, showing resistivity values versus the rGO concentration. PA11 powder without graphene coating is insulating.

TABLE 6
Resistivity measurements of XLPE powder for various
samples with varying graphene concentrations.
Each row concerns a different sample.

| Graphene concentration | Volume resistivity |
|---|---|
| (wt %) | (Ohm · cm) |
| 0.2 | isolating |
| 0.4 | 4592840.0 |
| 0.6 | 647185.6 |
| 0.6 | 1833785.6 |
| 0.6 | 491392.0 |
| 0.6 | 400372.8 |
| 0.6 | 338837.1 |
| 0.6 | 619824.0 |
| 0.8 | 351792.0 |
| 1 | 541368.8 |
| 1.4 | 625408.0 |
| 1.4 | 521545.6 |
| 1.4 | 550024.0 |
| 1.4 | 671755.2 |
| 1.4 | 601955.2 |
| 1.4 | 588553.6 |
| 1.4 | 771708.8 |
| 1.5 | 219451.2 |

The flowability of the coated XLPE powder was measured for samples with 0.6 wt % and 1.4 wt % rGO according to ASTM B213. The sample with 0.6 wt % rGO showed an average flowtime of 67.4 s/50 g, deviation 1.3 s/50 g (1.9%). The sample with 0.6 wt % rGO showed an average flowtime of 70.5 s/50 g, deviation 0.37 s/50 g (0.5%). The XLPE powder without graphene coating did not flow at all through the funnel, so no flowtime could be determined.

### Example 6: PA11

PA11 was coated within the concentration range of 0.021-1.4 wt % rGO. Table 7 shows the obtained volume resistivity values for the various concentrations. The results are also shown in the graph of FIG. 8, showing resistivity values versus the rGO concentration. PA11 powder without graphene coating is insulating.

TABLE 7
Resistivity for PA11 polymer powder with
various graphene coating concentrations.

| Graphene concentration | Volume resistivity |
|---|---|
| (wt %) | (Ohm · cm) |
| 0.07 | 1690000 |
| 0.1 | 1485583 |
| 0.3 | 183729 |
| 0.4 | 693533 |
| 0.5 | 778968 |
| 0.6 | 969383 |
| 0.65 | 187846 |
| 0.75 | 56125 |
| 0.8 | 106305 |
| 0.85 | 84949 |
| 0.9 | 78413 |
| 0.95 | 40858 |
| 1 | 124417 |
| 1.1 | 99579 |
| 1.2 | 102394 |
| 1.3 | 76635 |
| 1.4 | 91075 |

Parts printed with SLS of PA11 powder coated with various rGO coating concentrations exhibited volume resistivities presented in Table 8 below. At a concentration of 0.021 wt % rGO, the resistivity was higher than the experimental setup could detect. The more rGO was present, the lower the resistivity.

TABLE 8
Volume resistivity for parts printed with PA11 polymer powder
with various graphene coating concentrations using SLS

| Graphene concentration (wt %) | Volume resistivity (Ohm · cm) |
|---|---|
| 0 | — |
| 0.021 | — |
| 0.05 | 333320 |
| 0.07 | 25335 |
| 0.21 | 4761 |
| 0.3 | 1841 |
| 0.85 | 1136 |

### Example 7

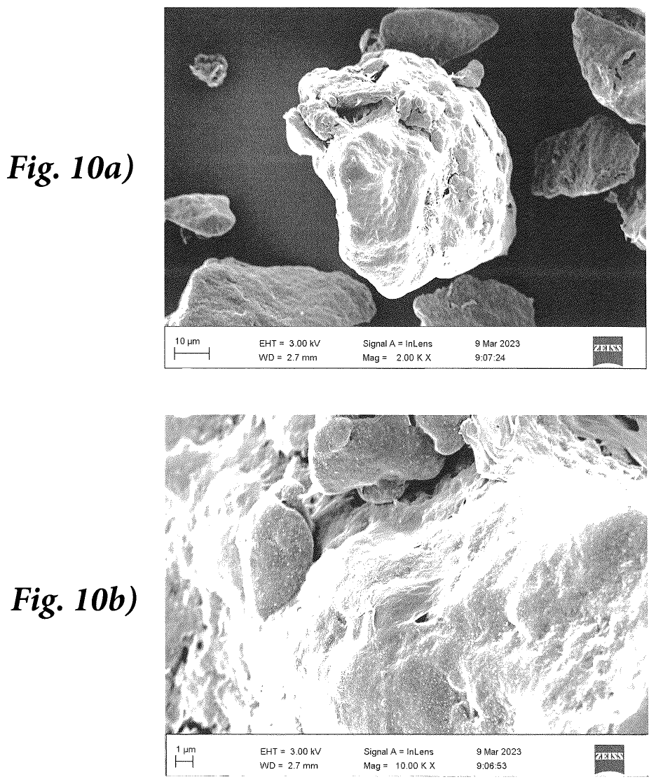

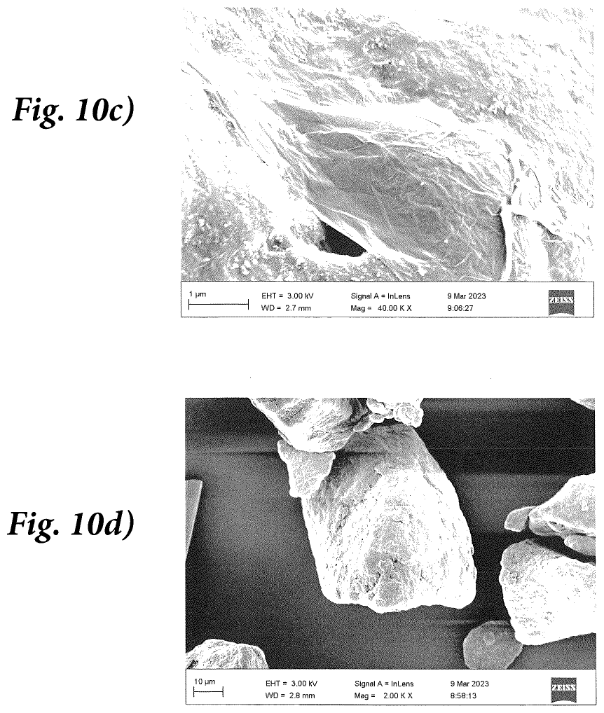

FIGS. 10 a), 10 b) and 10 c) show SEM images of PA11-based composite powder material coated with 0.3 wt % (reduced) graphene oxide with increasing magnification. The PA11 used here is the product known as PA11 Onyx produced by Sinterit for SLS applications and comprises carbon black. It can be seen that the particle is well covered by the graphene coating. The composite particles in FIGS. 10 a) and 10 b) are coated with 0.3 wt % of graphene. The reference of FIG. 10 c) is an uncoated polymer sample. The image of FIG. 10 b) is a zoomed in part in the middle of the image of FIG. 10a), and the image of FIG. 10c) is a zoomed in part of the middle of the image of FIG. 10b).

TABLE 9
Properties of the uncoated PA11 powder comprising carbon black.

| Properties | | | Test method |
|---|---|---|---|
| Material type | Nylon 11 | | |
| Colour | black | | |
| Particle size | 20-80 | μm | ISO 13320 |
| Mean particle size | 40 | μm | ISO 13320 |
| Printout density | 1.03 | g/cm³ | PN-EN ISO 845: 2010 |
| Melting point | 200 | ° C. | PN-EN ISO 11357-3: 2018 |
| Tensile Strength | 48 | MPa | PN-EN ISO 527-2: 2012 |
| Elongation at Break | 55 | MPa | PN-EN ISO 527-2: 2012 |
| Tensile Modulus | 1680 | MPa | PN-EN ISO 527-2: 2012 |

### Comparison with de Leon et al

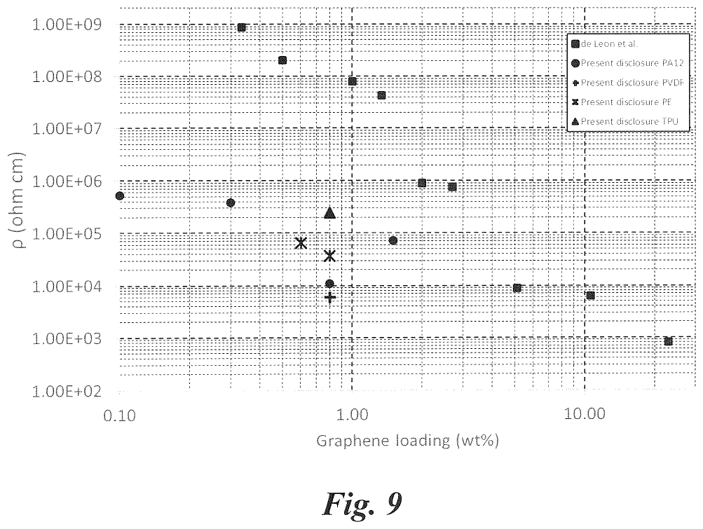

FIG. 9 shows a log-log plot of conductivity data from the paper of de Leon et al. cited above and converted to resistivity values for various graphene concentrations in PA powder. Graphene concentrations given in vol % by de Leon et al. are converted to weight % based on 1 wt % of GO being equal to 0.36 vol % as mentioned by de Leon et al. This comparison shows that the present composite powder materials based on polyamide as claimed have a resistivity of about three orders of magnitude lower than the materials of de Leon et al., as can be seen from the log-log scale plot (FIG. 9).

The disclosure further comprises the following embodiments:
1. A composite powder material comprising particulate polymer and graphene, wherein the particulate polymers are coated with graphene, and wherein the graphene concentration is 0.3-1.5% in weight per weight of the particulate polymer.
2. The composite powder material according to embodiment 1 wherein the concentration of graphene is approximately 0.6-1.5% in weight per weight of the particulate polymer.
3. The composite powder material according to embodiment 1 or 2 wherein the concentration of graphene is approximately 0.8-1.0% in weight per weight of the particulate polymer.
4. The composite powder material according to any of the preceding embodiments wherein the concentration of graphene is approximately 0.8% in weight per weight of the particulate polymer.
5. The composite powder according to any of the preceding embodiments wherein the graphene is reduced graphene oxide.
6. The composite powder material according to any of the preceding embodiments wherein the polymer is selected from the group consisting of polyamides, thermoplastic fluoropolymers, polyethers, and polyurethanes.
7. The composite material according to embodiment 6 wherein the polymer is a polyamide selected from the group consisting of PA6, PA11, PA12, PA66 and PA2200.
8. The composite material according to embodiment 6 wherein the polymer is a polyurethane selected from the group consisting of TPU polyesters such as Estane PW600.
9. The composite material according to embodiment 6 wherein the polymer is a polyethylene selected from the group consisting of low-density polyethylene.
10. The composite material according to embodiment 6 wherein the polymer is a polyvinyl polyvinyl fluoride selected from the group consisting of Piezotech FC20, and PVDF copolymers such as polyvinylidene fluoride-trifluoroethylene.
11. The composite powder material according to any of the preceding embodiments wherein the shape of the particulate polymers is spherical.
12. The composite powder material according to any of the preceding embodiments wherein the average particle size of the particulate polymer particles is 20-500 μm, preferably 50-80 μm.
13. A printed polymer product, manufactured from a composite powder material comprising particulate polymer and graphene, wherein the particulate polymers are coated with graphene, and wherein the graphene concentration is 0.3-1.5% in weight per weight of the particulate polymer and the printed product has a resistivity below 400000 ohm cm.

Although the present invention has been described with reference to specific embodiments, also shown in the appended drawings, it will be apparent to those skilled in the art that many variations and modifications can be done within the scope of the invention as described in the specification and defined with reference to the claims below.

1. A composite powder material comprising particulate polymer and graphene, wherein the particulate polymer is coated with graphene, and wherein the graphene concentration is 0.03-1.5% in weight per weight of the particulate polymer, wherein the polymer is selected from the group consisting of polyamide, thermoplastic fluoropolymer, polyethylene, and polyurethane, wherein the polyamide is selected from the group consisting of PA6, PA11, PA12, PA66.

2. The composite powder material according to claim 1, wherein the concentration of graphene is 0.05-1.5% in weight per weight of the particulate powder, preferably 0.3-1.5% in weight per weight of the particulate powder.

3. The composite powder material according to claim 1, wherein the concentration of graphene is 0.05%-0.85%, preferably 0.07-0.85%, in weight per weight of the particulate polymer.

4. The composite powder material according to claim 1, wherein the concentration of graphene is approximately 0.8% in weight per weight of the particulate polymer.

5. The composite powder according to claim 1, wherein the graphene is reduced graphene oxide or graphene oxide.

6. The composite powder material according to claim 1, wherein the polymer is PA11, wherein preferably the concentration of graphene is 0.05-1.4%, preferably 0.07-1.4%, in weight per weight of the particulate powder.

7. The composite material according to claim 1, wherein the polymer is polyester thermoplastic polyurethane (TPU).

8. The composite material according to claim 1, wherein the polymer is low-density polyethylene or high-density polyethylene, wherein preferably the concentration of graphene is 0.5-1%, more preferably 0.5-0.9%, most preferably 0.6-0.8% in weight per weight of the particulate powder.

9. The composite material according to claim 1, wherein the polymer is cross-linked polyethylene, such as cross-linked high-density polyethylene.

10. The composite material according to claim 1, wherein the thermoplastic fluoropolymer is a polyvinyl fluoride, such as poly(vinylidene fluoride-trifluoroethylene).

11. The composite powder material according to claim 1, wherein the shape of the particulate polymer is spherical.

12. The composite powder material according to claim 1, wherein an average particle size of the particulate polymer is 20-1000 μm, preferably 20-700 μm, more preferably 20-500 μm.

13. A printed polymer product, manufactured from a composite powder material according to claim 1, wherein the printed product has a resistivity below 400000 ohm cm.

14. The printed polymer product according to claim 13, manufactured using selective laser sintering.

15. An extruded polymer product, manufactured from a composite powder material according to claim 1.

16. A molded polymer product, manufactured from a composite powder material according to claim 1, wherein the molded polymer product is preferably injection molded, blow molded or rotational-molded.
